(19) United States
(12) Patent Application Publication
(10) Pub. No.: US 2022/0374677 A1
(43) Pub. Date: Nov. 24, 2022

(54) DATA PROCESSING APPARATUS AND METHOD FOR DEEP LEARNING INFERENCE FRAMEWORK

(71) Applicant: SAMSUNG ELECTRONICS CO., LTD., Suwon-si (KR)

(72) Inventors: Zhe WANG, Xi'an (CN); Yongzhen TIAN, Xi'an (CN); Zengzeng SUN, Xi'an (CN); Xin LU, Xi'an (CN)

(73) Assignee: SAMSUNG ELECTRONICS CO., LTD., Suwon-si (KR)

(21) Appl. No.: 17/744,150

(22) Filed: May 13, 2022

(30) Foreign Application Priority Data
May 18, 2021 (CN) 202110539151.4
Apr. 5, 2022 (KR) 10-2022-0042253

(51) Int. Cl. G06N 3/04; G06N 3/08

(52) U.S. Cl. CPC G06N 3/04; G06N 3/08

(57) ABSTRACT

A method includes determining whether an inference framework for a deep learning inference framework supports a first data arrangement scheme of a machine learning inference model; determining, in response to the inference framework not supporting the first data arrangement scheme, a data arrangement scheme conversion strategy of input data and output data of an inference operator of the inference framework, based on a dimension of the input data received by the inference operator, a dimension of the output data output corresponding to the input data, and a correlation between the inference operator and the data arrangement scheme; and converting either a data arrangement scheme of the input data or the output data of the inference operator based on the determined data arrangement scheme conversion strategy.

### CROSS-REFERENCE TO RELATED APPLICATIONS

This application claims the benefit under 35 USC § 119(a) of Chinese Patent Application No. 202110539151.4 filed on May 18, 2021, at the China National Intellectual Property Administration, and Korean Patent Application No. 10-2022-0042253, filed on Apr. 5, 2022, at the Korean Intellectual Property Office, the entire disclosures of which are incorporated herein by reference for all purposes.

### BACKGROUND

### 1. Field

The following examples relate a data processing apparatus and method with a deep learning inference framework.

### 2. Description of Related Art

With the widespread application of deep learning technology, neural network models with better performance and training frameworks and inference frameworks for neural network models suitable for various scenes continue to emerge.

FIG. 1 illustrates an example of a deep learning task deployment according to a related art.

Referring to FIG. 1, deployment of a neural network model may be divided into two operations. In a first operation 110, a neural network model may be trained based on a training framework 111 using the powerful computing power of a server. In a second operation 120, an inference process may be performed on a neural network model (original model) 130 trained in the first operation, based on an inference framework 121 at a mobile end or a service end, to realize a corresponding task goal.

The neural network model 130 may include a plurality of operators.

FIG. 2 is a schematic diagram illustrating an example of a neural network model according to a related art.

Referring to FIG. 2, the neural network model 130 may include neural network layers such as an input layer (Input) 210, an output layer (Output) 230, convolution layers (Conv) 212, 214, 216, and 224, a connection layer (Concat) 222, depthwise separable convolution layers (Depthwise Conv) 218 and 220, a reconstruction layer (Reshape) 226, a long short term memory (LSTM) 228, and the like. Here, an operator may be divided into the following two types.

1) An operator that is related to a data arrangement scheme (layout), and may be implemented in two types of data arrangement scheme, NHWC and NCHW, in which N represents quantity, C represents channel, H represents height, and W represents width.

2) An operator that is not related to the layout, and the implementation of such type of operator is not related to the data arrangement scheme.

Current mainstream training frameworks for neural network models may support a different layout due to different software and hardware optimization approaches.

For example, referring to FIG. 1, the NCHW array represented by Caffe and PyTorch and the NHWC array represented by Tensorflow may allow operators of a trained neural network model to have different layout properties.

In a process of inference based on the original model 130, the inference framework 121 may need to generate corresponding inference operators for different operators of the original model 130. Currently, due to the performance of hardware equipment and the cost of software optimization, a default implementation of an inference operator of the inference framework 121 may generally support only one layout. Therefore, when an operator layout of the original model 130, which is the neural network model, is different from an inference operator layout of the inference framework 121, an additional data conversion task may need to be added.

In the related art, a data conversion task adopted in an inference operation may include mainly two schemes.

Scheme 1) Performing data conversion for each operator related to the layout.

Scheme 2) Traversing a topology result of the original model, dividing the original model into sub-blocks of a different layout, and inserting a layout conversion operator between the blocks.

However, the performance loss of the two data conversion schemes is still relatively large when the inference operation is performed.

Therefore, a method to reduce performance loss due to data conversion may be desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method includes determining whether an inference framework for a deep learning inference framework supports a first data arrangement scheme of a machine learning inference model; determining, in response to the inference framework not supporting the first data arrangement scheme, a data arrangement scheme conversion strategy of input data and output data of an inference operator of the inference framework, based on a dimension of the input data received by the inference operator, a dimension of the output data output corresponding to the input data, and a correlation between the inference operator and the data arrangement scheme; and converting either a data arrangement scheme of the input data or the output data of the inference operator based on the determined data arrangement scheme conversion strategy.

The method may further include pre-processing the input data based on the dimension of the input data before inputting the input data to a first layer inference operator of the inference framework. The pre-processing may include converting, in response to the dimension of the input data being a predetermined dimension, the first data arrangement scheme of the input data into a second data arrangement scheme, different from the first data arrangement scheme, supported by the inference framework. The predetermined dimension may be determined based on the second data arrangement scheme supported by the inference framework and the first data arrangement scheme of the machine learning inference model.

The method may further include post-processing output data output from a last layer inference operator of the inference framework, based on a dimension of the output data output from the last layer inference operator of the inference framework. The post-processing may include converting, in response to a dimension of the data output from the last layer inference operator of the inference framework being the predetermined dimension, a data arrangement scheme of the data output from the last layer inference operator of the inference framework into the second data arrangement scheme supported by the machine learning inference model.

The determining of the data arrangement scheme conversion strategy of the input data and the output data of the inference operator may include verifying whether parameters of the inference operator are related to the data arrangement scheme of the input data and the output data, verifying whether implementation of the inference operator is not related to the data arrangement scheme of the input data and the output data, and verifying whether the dimension of the input data received by the inference operator and the dimension of the output data output corresponding to the input data comprise only four conditions. The four conditions may include a first condition of receiving input data of the predetermined dimension and outputting output data of the predetermined dimension, a second condition of receiving input data of a non-predetermined dimension and correspondingly outputting output data of the non-predetermined dimension, a third condition of receiving the input data of the predetermined dimension and correspondingly outputting the output data of the non-predetermined dimension, and a fourth condition of receiving the input data of the non-predetermined dimension and correspondingly outputting the output data of the predetermined dimension.

The determining of the data arrangement scheme conversion strategy of the input data and the output data of the inference operator may include converting the data arrangement scheme of the input data input to the inference operator into the first data arrangement scheme of the machine learning inference model in the third condition, in response to the dimension of the input data received by the inference operator and the dimension of the output data output corresponding to the input data comprising only the four conditions based on a result of the verifying.

The determining of the data arrangement scheme conversion strategy of the input data and the output data of the inference operator may include converting the data arrangement scheme of the output data of the inference operator into the second data arrangement scheme supported by the inference framework in the fourth condition, in response to the dimension of the input data received by the inference operator and the dimension of the output data output corresponding to the input data comprising only the four conditions based on the result of the verifying.

The determining of the data arrangement scheme conversion strategy of the input data and the output data of the inference operator may include not converting the data arrangement schemes of the input data and the output data of the inference operator in the first condition and the second condition, in response to the dimension of the input data received by the inference operator and the dimension of the output data output corresponding to the input data comprising only the four conditions based on the result of the verifying.

The determining of the data arrangement scheme conversion strategy of the input data and the output data of the inference operator may include verifying whether the parameters of the inference operator are related to the data arrangement scheme, verifying whether implementation of the inference operator is not related to the data arrangement scheme, and verifying whether the dimension of the input data received by the inference operator and the dimension of the output data output corresponding to the input data comprise only two conditions. The two conditions may include a first condition of receiving input data of a predetermined dimension and outputting output data of the predetermined dimension, and a second condition of receiving input data of a non-predetermined dimension and correspondingly outputting output data of the non-predetermined dimension.

The determining of the data arrangement scheme conversion strategy of the input data and the output data of the inference operator may include not converting the data arrangement schemes of the input data and the output data of the inference operator and adjusting the parameters of the inference operator in the second condition, in response to the dimension of the input data received by the inference operator and the dimension of the output data output corresponding to the input data comprising only the two conditions based on the result of the verifying.

The determining of the data arrangement scheme conversion strategy of the input data and the output data of the inference operator may include not converting the data arrangement schemes of the input data and the output data of the inference operator and not adjusting the parameters of the inference operator in the first condition, in response to the dimension of the input data received by the inference operator and the dimension of the output data output corresponding to the input data comprising only the two conditions based on the result of the verifying.

The determining of the data arrangement scheme conversion strategy of the input data and the output data of the inference operator may include determining the data arrangement scheme conversion strategy of the input data and the output data of the inference operator in response to the inference operator being executed, or determining the data arrangement scheme conversion strategy of the input data and the output data of the inference operator prior to the inference operator being executed.

The predetermined dimension may be 4, and the first data arrangement scheme of the machine learning inference model may be NHWC, and the second data arrangement scheme supported by the inference framework may be NCWH, or the first data arrangement scheme of the machine learning inference model may be NCWH, and the second data arrangement scheme supported by the inference framework may be NHWC.

A non-transitory computer-readable storage medium storing instructions that, when executed by a processor, cause the processor to perform the method above.

In another general aspect, a data processing apparatus includes a conversion strategy determiner configured to, in response to an inference framework for a deep learning inference framework not supporting a first data arrangement scheme of a machine learning inference model, determine a data arrangement scheme conversion strategy of input data and output data of an inference operator of the inference framework, based on a dimension of the input data received by the inference operator, a dimension of the output data output corresponding to the input data, and a correlation between the inference operator and the data arrangement scheme; and an executor configured to convert either a data arrangement scheme of the input data or output data of the inference operator based on the determined data arrangement scheme conversion strategy.

The apparatus may further include a pre-processor configured to: pre-process the input data based on the dimension of the input data before inputting the input data to a first layer inference operator of the inference framework; and convert, in response to the dimension of the input data being a predetermined dimension, the data arrangement scheme of the input data into a second data arrangement scheme, different from the first data arrangement scheme, supported by the inference framework. The predetermined dimension may be determined based on the second data arrangement scheme supported by the inference framework and the first data arrangement scheme of the machine learning inference model.

The apparatus may further include a post-processor configured to: post-process output data output from a last layer inference operator of the inference framework, based on a dimension of the output data output from the last layer inference operator of the inference framework; and convert, in response to a dimension of the data output from the last layer inference operator of the inference framework being the predetermined dimension, a data arrangement scheme of the data output from the last layer inference operator of the inference framework into the second data arrangement scheme supported by the machine learning inference model.

The conversion strategy determiner may be further configured to verify whether parameters of the inference operator are related to the data arrangement scheme, and implementation of the inference operator is not related to the data arrangement scheme, and the dimension of the input data received by the inference operator and the dimension of the output data output corresponding to the input data comprise only four conditions. The four conditions may include a first condition of receiving input data of the predetermined dimension and outputting output data of the predetermined dimension, a second condition of receiving input data of a non-predetermined dimension and correspondingly outputting output data of the non-predetermined dimension, a third condition of receiving the input data of the predetermined dimension and correspondingly outputting the output data of the non-predetermined dimension, and a fourth condition of receiving the input data of the non-predetermined dimension and correspondingly outputting the output data of the predetermined dimension.

The conversion strategy determiner may be further configured to: in response to the dimension of the input data received by the inference operator and the dimension of the output data output corresponding to the input data comprising only the four conditions based on the result of the verifying, not convert the data arrangement schemes of the input data and the output data of the inference operator in the first condition and the second condition; convert the data arrangement scheme of the input data input to the inference operator into the first data arrangement scheme of the machine learning inference model in the third condition; and convert the data arrangement scheme of the output data of the inference operator into the second data arrangement scheme supported by the inference framework in the fourth condition.

The conversion strategy determiner may be further configured to: verify whether the parameters of the inference operator are related to the data arrangement scheme, and implementation of the inference operator is not related to the data arrangement scheme. The dimension of the input data received by the inference operator and the dimension of the output data output corresponding to the input data may include only two conditions. The two conditions may include a first condition of receiving input data of a predetermined dimension and outputting output data of the predetermined dimension, and a second condition of receiving input data of a non-predetermined dimension and correspondingly outputting output data of the non-predetermined dimension.

The conversion strategy determiner may be further configured to: in response to the dimension of the input data received by the inference operator and the dimension of the output data output corresponding to the input data comprising only the two conditions based on the result of the verifying, not convert the data arrangement schemes of the input data and the output data of the inference operator and not adjust the parameters of the inference operator in the first condition; and not convert the data arrangement schemes of the input data and the output data of the inference operator and adjust the parameters of the inference operator in the second condition.

Other features and aspects will be apparent from the following detailed description, the drawings, and the claims.

### BRIEF DESCRIPTION OF THE DRAWINGS

FIG. 1 illustrates an example of a deep learning task deployment according to a related art.

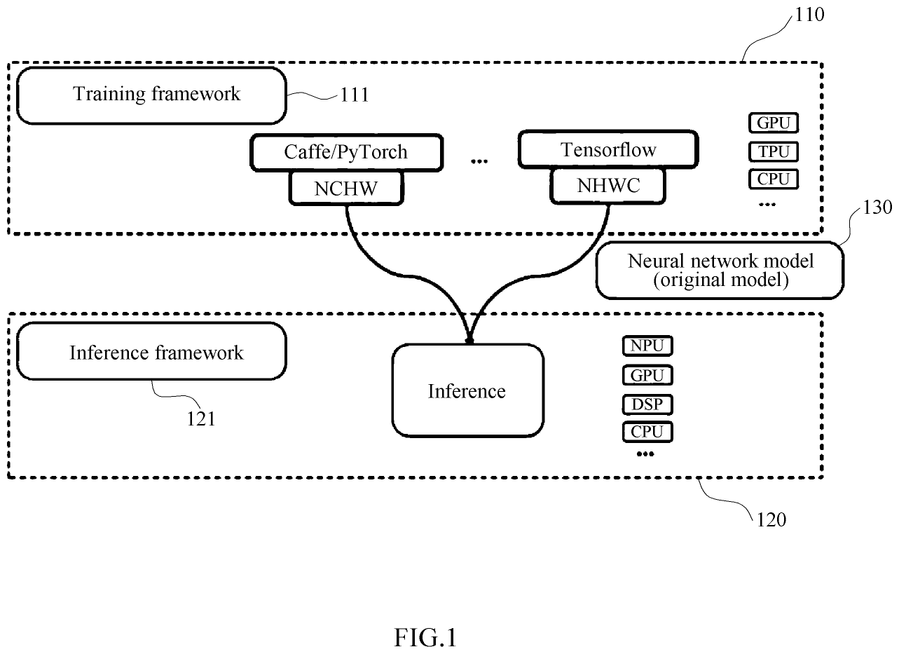

FIG. 2 illustrates an example of a neural network model according to a related art.

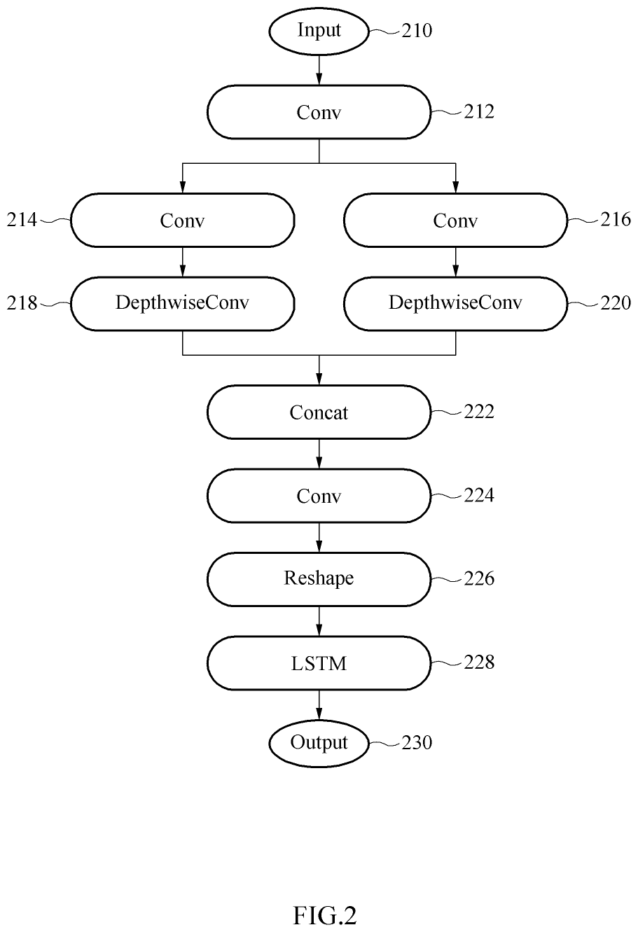

FIG. 3 illustrates an example of a first data conversion scheme adopted in an inference operation.

FIG. 4 illustrates an example of a second data conversion scheme adopted in an inference operation.

FIG. 5 is a flowchart illustrating an example of a data processing method of a deep learning inference framework.

FIG. 6 is a block diagram illustrating an example of a data processing apparatus for a deep learning inference framework.

FIG. 7 illustrates an example of a structure of a deep learning inference framework.

FIG. 8 is a flowchart illustrating an example of a method of performing a conversion of a data arrangement scheme.

FIG. 9 illustrates an example of a data processing method of a deep learning inference framework.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

Causes for the issues with respect to the two schemes of the data conversion task described in the description of the related art may be as follows. Herein, it is noted that use of the term ‘may’ with respect to an example or embodiment, e.g., as to what an example or embodiment may include or implement, means that at least one example or embodiment exists where such a feature is included or implemented while all examples and embodiments are not limited thereto.

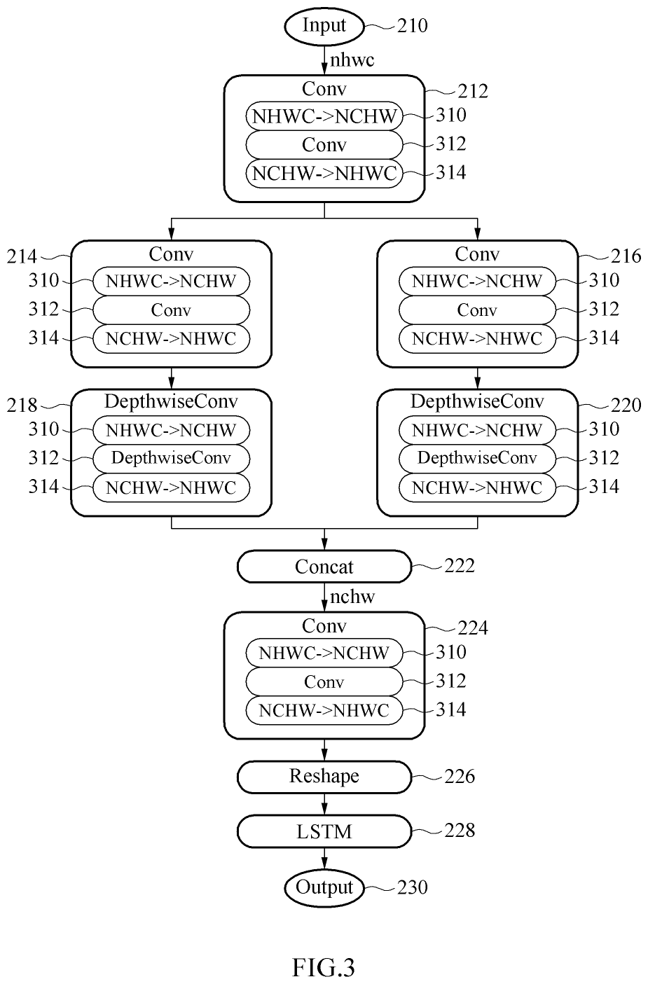

First, a data conversion task in the case of scheme 1) is described with reference to FIG. 3 below.

FIG. 3 illustrates an example of a first data conversion scheme adopted in an inference operation.

Referring to FIG. 3, a layout supported by an inference operator of an inference framework may be NCHW, and a layout supported by an original model (a neural network model) may be NHWC. Accordingly, data conversion may need to be performed with respect to each operator related to a layout.

When the inference framework performs inference on the original model, an operator may need to be generated based on the structure information of the original model to perform an inference calculation. For example, in an inference execution operation, a layout of data transmitted between generated inference operators may need to match a layout supported by the original model (i.e., the neural network model), and when the layout of the data transmitted between the inference operators does not match the layout supported by the original model, data conversion may need to be performed in an internal calculation of the inference operator.

Referring to FIG. 3, an operator related to a layout may include a convolutional (Conv) layer and a depthwise separable convolution (DepthwiseConv) layer. Three operations may need to be implemented in the execution process of each corresponding inference operator.

1) Convert a layout of input data from NHWC to NCHW 310.

2) Execute calculation 312.

3) Convert a layout of output data from NCHW to NHWC and transmit to an operator of a next layer 314.

In scheme 1), data conversion may need to be performed for every operator related to the layout. Therefore, based on an analysis, when the original model includes N operators related to a layout, 2*N data conversions may need to be performed in the inference operation, and since such type of operators may commonly occupy a high proportion in neural network models, it can be seen that a large performance loss may occur in the execution of the original model in the inference operation, since the number of data conversions may increase linearly as the depth of the original model may increase.

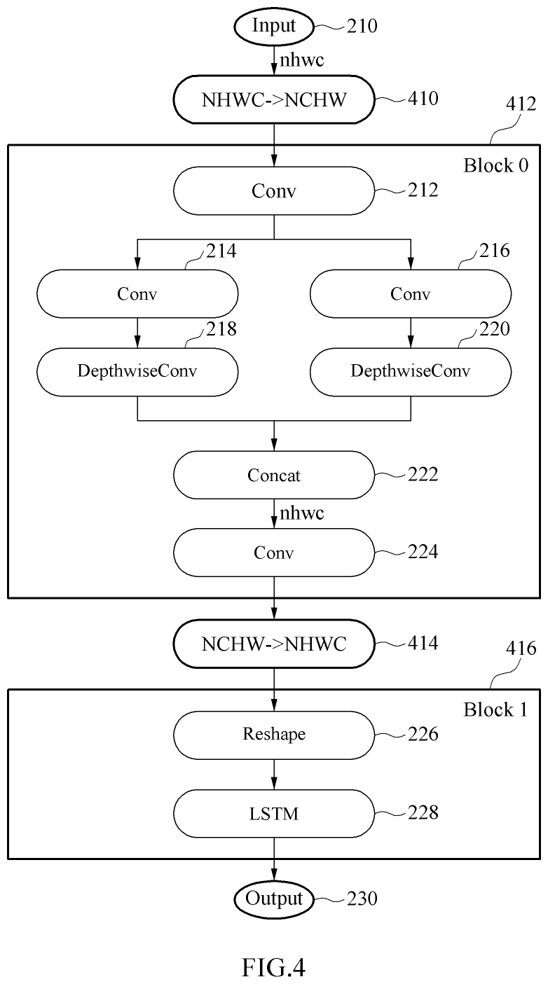

A data conversion task in the case of scheme 2) is described with reference to FIG. 4 below.

FIG. 4 illustrates an example of a second data conversion scheme adopted in an inference operation.

Referring to FIG. 4, a layout supported by an inference operator of an inference framework may be NCHW, and a layout supported by an original model (a neural network model) may be NHWC. Accordingly, even in the inference operation, data conversion may need to be performed with respect to each operator related to a layout.

The difference between scheme 2) and scheme 1) may be that, before the inference framework performs inference on the original model, the inference framework may traverse a topology of the original model, divide the original model into a sub-block with a different layout, and then insert an operator with a converted layout between the blocks.

Specifically, referring to FIG. 4, after dividing the original model into a block 0 412 and a block 1 416, a converted operator may be inserted between the block 0 412 and the block 1 416 to convert a data arrangement from NCHW to NHWC 414. By inserting the converted operator between an input 210 and the block 0 412, the data arrangement may be converted from NHWC to NCHW 410.

Scheme 2 may significantly reduce the number of data conversions, thereby reducing performance loss that may occur in the inference process of the model. However, based on an analysis of scheme 2), it can be seen that before the inference framework performs inference on the original model, the inference framework may traverse the topology of the original model, and determine that layout properties of each operator and related operators have complex software implementation logic, which may affect maintainability and flexibility of the software. In addition, as topologies of neural network models become more complex, time complexity and spatial complexity of graph traversal may also increase, resulting in additional performance loss and burden of power consumption in an inference execution process.

For the above-mentioned reasons, the present inventor thought that the inference framework should reduce the number of data conversions and avoid graph traversal in the inference process of the original model, which may reduce performance loss in the inference operation to some extent. Based on this idea, the present inventor discovered the following through repeated study.

In a neural network model, since an operator related to a layout is characterized in that a dimension (rank) of input/output data is 4, rank information may be considered the main criterion for determining the conversion of a data arrangement scheme. Specifically, data with a rank of 4 may be assigned to a layout property (e.g., NCHW or NHWC) that is supported in implementing the inference operator of the inference framework. Then, the same layout properties as the original model may be maintained in data having a rank that is not 4. Accordingly, a data conversion task may appear only in an operator of which a data dimension (rank) is changed, and the number of the operators in which the dimension (rank) is changed may be far lesser than the operators related to the layout. As a result, it may be possible to significantly reduce the data conversion tasks of the model in the inference operation, thereby increasing the inference performance of the deep learning inference framework for various layout models. In addition, graph traversal and graph segmentation are not required, so the determination logic of data conversion may be significantly simplified, thereby reducing software development and maintenance costs.

In this respect, a data processing method for a deep learning inference framework is provided in accordance with an aspect of an example of the present disclosure.

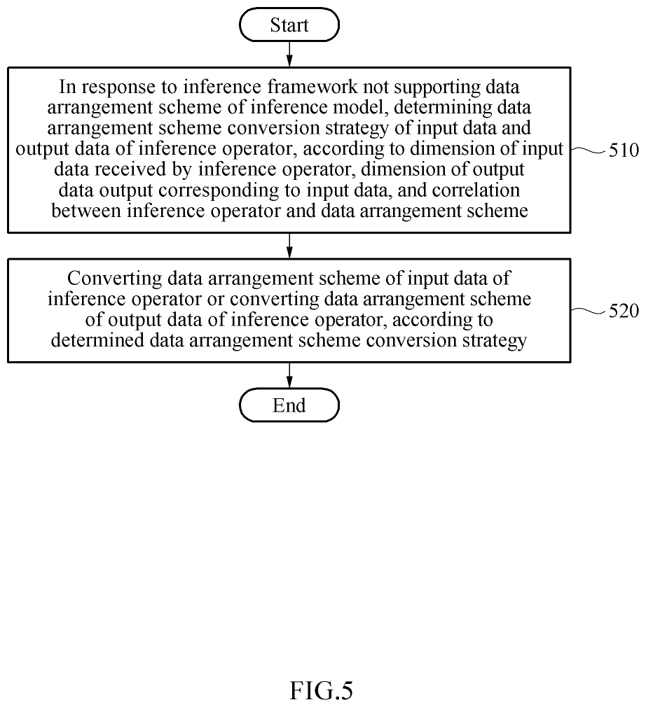

FIG. 5 is a flowchart illustrating an example of a data processing method of a deep learning inference framework.

Referring to FIG. 5, the data processing method may include operations 510 and 520.

In operation 510, the data processing method may include, in response to an inference framework not supporting a data arrangement scheme of an inference model, determining a data arrangement scheme conversion strategy of input data and output data of an inference operator, according to a dimension of the input data received by the inference operator, a dimension of the output data output corresponding to the input data, and a correlation between the inference operator and the data arrangement scheme.

In operation 520, the data processing method may include converting a data arrangement scheme of the input data of the inference operator or converting a data arrangement scheme of the output data of the inference operator, according to the determined conversion strategy.

For example, when the inference framework does not support the data arrangement scheme of the inference model, the input data may be pre-processed according to the dimension of the input data before the input data is input to a first layer inference operator of the inference framework. In this example, when the dimension of the input data is a predetermined dimension, the data arrangement scheme of the input data may be converted into a data arrangement scheme supported by the inference framework in the pre-processing operation. Here, the predetermined dimension may be determined according to the data arrangement scheme supported by the inference framework and the 0 of the inference model.

For example, when the inference framework supports NCHW and the inference model supports NHWC, since the dimensions of NHWC and NCHW may be 4, and a dimension of data based on an NHWC and NCHW format may be 4; accordingly, the predetermined dimension may be determined as 4. The pre-processing operation may include, converting the data arrangement scheme of the input data, which is NHWC, into the data arrangement scheme supported by the inference framework, which is NCHW, in response to the dimension of the input data being 4, before inputting data into the first layer inference operator. When the dimension of the input data is not 4, conversion of the arrangement scheme of the input data may not be performed in the pre-processing operation.

In an example, output data output from a last layer inference operator of the inference framework may be post-processed according to a dimension of the data output from the last layer inference operator of the inference framework. In this example, when the dimension of the data output from the last layer inference operator of the inference framework is the predetermined dimension, a data arrangement scheme of the data output from the last layer inference operator of the inference framework may be converted into the data arrangement scheme supported by the inference model in the post-processing operation.

Specifically, in an example in which the inference framework supports NCHW and the inference model supports NHWC, the post-processing operation may include, converting the data arrangement scheme of the data output from the last layer inference operator of the inference framework, which is NCWH, into the data arrangement scheme supported by the inference model, which is NHWC, when the dimension of the data output from the last layer inference operator of the inference framework is 4. In addition, when the dimension of the data output from the last layer inference operator of the inference framework is not 4, the data arrangement scheme of the output data may not be converted.

In an example, the determining of the data arrangement scheme conversion strategy of the input data and the output data of the inference operator may include verifying whether the parameters of the inference operator are related to the data arrangement scheme, verifying whether the implementation of the inference operator is not related to the data arrangement scheme, and verifying whether the dimension of the input data received by the inference operator and the dimension of the output data output corresponding to the input data include only four conditions (as described below).

Here, the four conditions are as follows:

A first condition is in which input data of the predetermined dimension is received, and output data of the predetermined dimension is output;

A second condition is in which the input data of the non-predetermined dimension is received, and the output data of the non-predetermined dimension is correspondingly output;

A third condition is in which the input data of the predetermined dimension is received, and the output data of the non-predetermined dimension is correspondingly output;

A fourth condition is in which the input data of the non-predetermined dimension is received, and the output data of the predetermined dimension is correspondingly output.

According to a result of the verification, when the dimension of the input data received by the inference operator and the dimension of the output data output corresponding to the input data include only the four conditions, the data processing method may determine a conversion strategy for the inference operator in each condition as described below.

In the case of the first condition and the second condition, the data processing method may not change the data arrangement scheme of the input data and the output data.

In the case of the third condition, the data processing method may convert the data arrangement scheme of the input data input to the inference operator into the data arrangement scheme of the inference model.

In the case of the fourth condition, the data processing method may convert the data arrangement scheme of the output data of the inference operator into the data arrangement scheme supported by the inference framework.

In an example, the determining of the data arrangement scheme conversion strategy of the input data and the output data of the inference operator may include verifying whether the parameters of the inference operator are related to the data arrangement scheme, verifying whether the implementation of the inference operator is not related to the data arrangement scheme, and verifying whether the dimension of the input data received by the inference operator and the dimension of the output data output corresponding to the input data include only two conditions (as described below).

Here, the two conditions are as follows:

A first condition is in which input data of the predetermined dimension is received, and output data of the predetermined dimension is output; and

A second condition is in which the input data of the non-predetermined dimension is received, and the output data of the non-predetermined dimension is correspondingly output.

According to a result of the verification, when the dimension of the input data received by the inference operator and the dimension of the output data output corresponding to the input data include only the two conditions, the data processing method may determine a conversion strategy for the inference operator in each condition as described below.

In the case of the first condition, the data processing method may not need to convert the arrangement schemes of the input data and the output data, nor adjust the parameters of the inference operator.

In the case of the second condition, the data processing method may not convert the data arrangement schemes of the input data and the output data of the inference operator, but adjust the parameters of the inference operator.

Specifically, the inference operator may be divided into four types (e.g., a type A operator, a type B operator, a type C operator, and a type D operator).

Hereinafter, an example is described under the assumption that the inference framework supports NCHW, and the inference model supports NHWC.

The type A operator may be an inference operator in which implementation of the inference operator (i.e., software implementation of the inference operator), parameters of the inference operator, and data supported by an inference model corresponding to the inference operator are all related to a layout, and in which the inference operator receives only four-dimensional (4D) input data and outputs 4D output data accordingly. A conversion strategy of the type A operator may be determined not to convert a data arrangement scheme of the input data and the output data.

The type B operator may be an inference operator in which the parameters of the inference operator are related to the data arrangement scheme, the implementation of the inference operator is not related to the data arrangement scheme, and a dimension of input data received by the inference operator and a dimension of output data correspondingly output include only two conditions.

Here, the two conditions are as follows:

when the 4D input data is received, and the 4D output data is correspondingly output (hereinafter, a B1 condition); and

when non-4D input data is received, and non-4D output data is correspondingly output (hereinafter, a B2 condition).

It may be determined that a conversion strategy of the type B operator may not be to convert the data arrangement schemes of the input data and the output data, and a conversion strategy of the type B operator in the B1 condition may be to adjust the parameters of the inference operator.

The type C operator may be an inference operator in which the implementation of the inference operator, the parameters of the inference operator, and data stored by the inference model corresponding to the inference operator are all not related to a layout, and in which the inference operator receives only non-4D input data and outputs non-4D output data accordingly.

It may be determined that a conversion strategy of the type C operator may not be to convert the data arrangement schemes of the input data and the output data, and not to adjust the parameters of the inference operator.

The type D operator may be an inference operator in which the parameters of the inference operator are related to the data arrangement scheme, the implementation of the inference operator is not related to the data arrangement scheme, and the dimension of input data received by the inference operator and the dimension of output data correspondingly output include only four conditions.

Here, the four conditions are as follows:

when the 4D input data is received, and the 4D output data is correspondingly output (hereinafter, a D1 condition);

when the non-4D input data is received, and the non-4D output data is correspondingly output (hereinafter, a D2 condition);

when the 4D input data is received, and the non-4D output data is correspondingly output (hereinafter, a D3 condition); and

when the non-4D input data is received, and the 4D output data is correspondingly output (hereinafter, a D4 condition).

A conversion strategy of the type D operator may be determined not to convert the data arrangement schemes of the input data and the output data and not to adjust the parameters of the inference operator, in the cases of the D1 condition and the D2 condition.

In addition, in the case of the D3 condition, the conversion strategy of the type D operator may be determined to convert the data arrangement scheme, NCHW, of the input data input to the inference operator into the data arrangement scheme, NHWC, of the inference model.

In addition, in the case of the D4 condition, it may be determined that the conversion strategy of the type D operator may be to convert the data arrangement scheme, NHWC, of the output data of the inference operator into the data arrangement scheme, NCHW, supported by the inference framework.

Meanwhile, it will be apparent after an understanding of the disclosure of this application that the example in which the inference framework supports NCHW, and the inference model supports NHWC is merely described for the purpose of illustration, and does not limit the present disclosure. For example, when the inference operator is executed, the data arrangement scheme conversion strategy of the input data and the output data of the inference operator may be determined. In other words, when a predetermined inference operator is executed, the conversion strategy of the corresponding inference operator may be determined, and the data arrangement scheme may also be converted according to the conversion strategy. For example, whenever an inference operator of each layer is executed, the conversion strategy of the inference operator of the corresponding layer may be determined.

For example, before the inference operator is executed, the data arrangement scheme conversion strategy of the input data and the output data of the inference operator may be determined. In other words, when the inference operator is not executed, the conversion strategy of the inference operator may be determined in advance. For example, when the inference model is being parsed, the conversion strategy of each inference operator may be determined.

It will be apparent after an understanding of the disclosure of this application that the example of the present disclosure in which the inference framework supports NCHW, and the inference model supports NHWC is merely described for the purpose of illustration, and does not limit the present disclosure.

In addition, a neural network model may be trained by a training framework, and based on a training data set, may perform a predetermined number of supervised iterations on an initial neural network model, and optimize model parameters to obtain a final neural network model.

For example, in an initialization operation of the inference model, a dimension of input data received by the inference operator, a dimension of output data correspondingly output, and a correlation between the inference operator and the data arrangement scheme (i.e., the correlation between: a layout; and parameters of an operator, implementation of an operator, and data stored by the inference model corresponding to the inference operator) may be obtained.

It will be apparent after an understanding of the disclosure of this application that: the parameters of the operator described herein may represent parameter information desired for a calculation process of the operator, such as a convolution weight, PAD, and the like; the implementation of the operator may represent a software implementation manner of the operator such as convolution, including schemes such as general matrix multiplication (GEMM), DEIRECT, and the like; and the data of the operator may represent the input data and output data processed by the operator.

For example, alternatively, a category of the operator may first be determined based on the dimensions of the input data and the output data of the inference operator and/or the correlation between the inference operator and the layout, and then based on the category of the operator, a conversion strategy may be determined for the inference operator.

For example, the operator may be categorized as the type A operator, the type B operator, the type C operator, or the type D operator according to the classification rule described above. Then, according to the category of the operator, the conversion strategy of the data arrangement scheme of the operator may be determined. <Table 1> shows layout correlations and examples of various types of operators. Referring to <Table 1>, “the input data dimension and output data dimension of the operator” are the data dimensions (rank) shown in <Table 1>, wherein M and N are both positive integers.

TABLE 1

| | | | Example of |
|---|---|---|---|
| Category | Layout correlation | Data Rank | operator |
| A | Strong correlation: implemen- | Output = | Convolution, |
| | tation of the operator, data | Input = 4 | Average |
| | stored by the inference model, | | Pooling |
| | and parameters of the operator | | |
| | are all related to the layout. | | |
| B | Weak correlation: the relevant | Output = | Concatena- |
| | parameters of the operator are | Input = N | tion, Softmax |
| | related to the layout, and the | | Element-wise |
| | implementation is not related | | |
| | to the layout. | | |
| C | Not relevant | Output = | LSTM, RNN |
| | | Input = N, | |
| | | N! = 4 | |
| D | Weak correlation: the param- | Output = M, | Reshape, |
| | eters of the operator are related | Input = N | Squeeze |
| | to the layout, and the implemen- | | |
| | tation is not related to the layout. | | |

Since the training framework may train the neural network model directly, when model parameters are transmitted to the inference framework, the training framework may understand that the model parameters are parameters of operators of each layer. To perform inference, the inference framework may need to generate a corresponding inference operator based on the parameters of the operators of each layer. For example, when one operator of the neural network model performs addition, the inference framework may generate a corresponding inference operator based on a parameter of an addition operator that may specifically perform an operation of the addition operation.

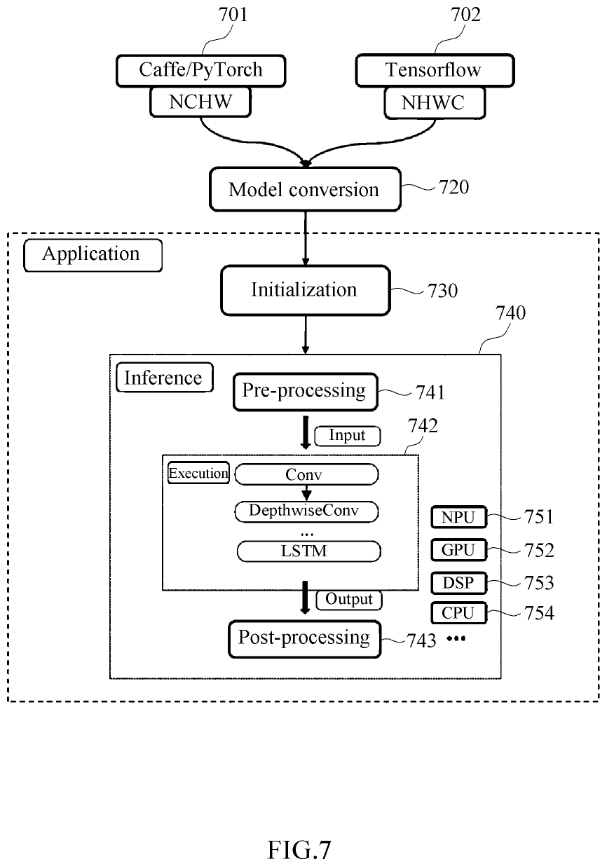

FIG. 7 illustrates an example of a deep learning inference framework structure.

Referring to FIG. 7, a process of generating an inference operator of a corresponding category for each operator may be performed in an initialization operation 730. In addition, in the initialization operation 730, besides generating an analysis model and an inference operator, tasks such as memory allocation and constant data conversion may be included.

Alternatively, a data processing method, according to an example, may further include an operation of executing model conversion 720 of an obtained neural network model trained by a different training framework. Specifically, referring to FIG. 7, the model conversion 720 may be performed on a neural network model obtained before initialization. In this example, the model conversion 720 may increase the inference performance of an inference framework by adjusting model parameters. The different training frameworks may be, for example, Caffe/PyTorch 701 or Tensorflow 702.

Continuing to refer to FIG. 7, the inference framework may realize an inference calculation using hardware configured differently according to a situation. The hardware may be, for example, a numeric processing unit (NPU) 751, a graphic processing unit (GPU) 752, a digital signal processor (DSP) 753, or a central processing unit (CPU) 754.

Specifically, an inference operation 740 may be divided into a pre-processing operation 741, an execution operation 742, and a post-processing operation 743. In the pre-processing operation 741, input data may be processed according to the above-described pre-processing operation, and the inference operator may convert input data or output data according to each conversion strategy. In the post-processing operation 743, data output by a last layer operator may be processed according to the above-described post-processing operation. The aforementioned operations are described in detail above, and accordingly, further description thereof is not repeated herein.

According to the description above presenting of the present disclosure, when the inference framework supports NCWH and the inference model supports NHWC, since an operator related to a layout in the network model may be characterized in that the dimension (rank) of the input/output data is 4, information of rank may be considered as the main criterion for determining a data conversion position.

Specifically, data having a rank of 4 may be assigned to a layout property (e.g., NCHW or NHWC) that is supported in the implementation of an inference operator of the inference framework. Then, the same layout properties as the original model may be maintained in data having a rank that is not 4. Accordingly, a data conversion task may appear only in an operator of which a data dimension (rank) is changed. In general, the number of such types of operators in which the data dimension is changed may be far less than the number of operators related to layouts in the neural network model. As a result, it may be possible to significantly reduce the data conversion tasks of the model in the inference operation 740, thereby increasing inference performance of the deep learning inference framework for various deep learning layout models. In addition, graph traversal and graph segmentation are not required, so a determination logic of data conversion may be significantly simplified, and software development and maintenance costs may be reduced.

According to an example, prior to an operator being executed, an arrangement scheme of the input data may be converted into a predetermined data arrangement scheme supported by the inference framework through the pre-processing operation (corresponding to a first layer operator) 741 or a previous operator.

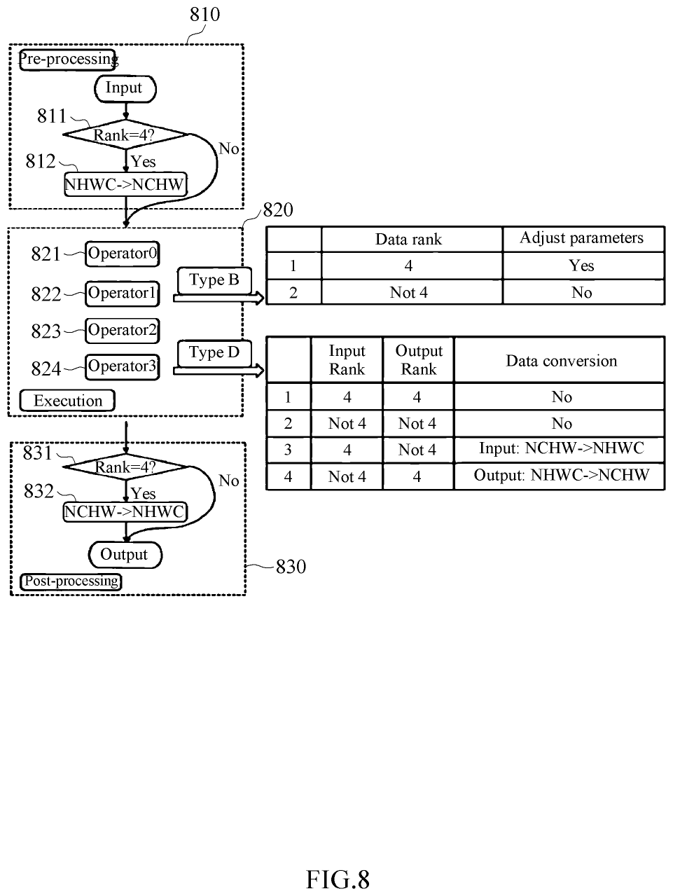

FIG. 8 is a flowchart illustrating an example of a method of performing a conversion of a data arrangement scheme.

For ease of understanding, the following description is provided under the assumption that a layout supported by an inference operator of an inference framework is an NCHW array, and a data arrangement scheme supported by the inference model is an NHWC array, with reference to Table 1 and FIG. 8.

In an example of B1, a data dimension of input data and output data may be 4, and a pre-processing operation may only need to adjust the parameters of an inference operator and then execute an inference calculation.

In the example of B1, the data processing method may determine parameters that need to be adjusted according to a situation. Here, an inference operator corresponding to a connection layer operator and an adjusted related parameter may be an axis of the NCHW array, and an inference operator corresponding to a convolution layer operator and the adjusted related parameter may be a weight.

In an example of B2, the data processing method may not need to adjust the parameters in the pre-processing operation and may directly execute the inference calculation.

In an example of a type C inference operator, a data arrangement scheme may not need to be converted.

In an example of D1 and D2, the data processing method may not need to convert the data arrangement scheme.

In an example of D3, the data processing method may convert received input data from the NCHW array to the NHWC array in response to the data dimension of the received input data being 4.

In an example of D4, the data processing method may convert output data calculated by the inference operator from the NHWC array to the NCHW array in response to the data dimension of the received input data being any positive integer other than 4.

The conversion of the received input data may correspond to the example of D3 of the type D operator. That is, in the example of D3, the data processing method may convert data received from an inference operator of a previous layer and then input the data to a current layer of the inference operator to perform a calculation.

The conversion of the output data obtained after the inference calculation may correspond to the example of D4 of the type D operator. That is, the data processing method may convert an arrangement scheme of the data calculated and output by the inference operator of the current layer, and then transmit the converted data to a next layer.

Referring to the example of FIG. 8, the layout supported by the inference operator of the corresponding inference framework may be the NCHW array, and the data arrangement scheme supported by the inference model may be the NHWC array. The data processing method may determine 811 whether the dimension of the input data is 4 in the pre-processing operation 810.

When it is determined in operation 811 that the dimension of the input data is 4, the data processing method may convert the layout of the input data from the NHWC array to the NCHW array 812.

When it is determined in operation 811 that the dimension of the input data is not 4, the data processing method may not convert the layout of the input data.

In an execution operation 820, operator 0 821 to operator 3 824 may all be inference operators. Here, operator 1 822 may be an inference operator corresponding to the type B operator. In addition, operator 3 824 may be an inference operator corresponding to the type D operator.

In a post-processing operation 830, the data processing method may determine 831 whether the data dimension of the output data of the inference model is 4.

When it is determined in operation 831 that the dimension of the output data is 4, the data processing method may perform data conversion and convert 832 the layout of the output data from the NCHW array to the NHWC array.

When it is determined in operation 831 that the dimension of the output data is not 4, the data processing method may not convert the layout of the output data.

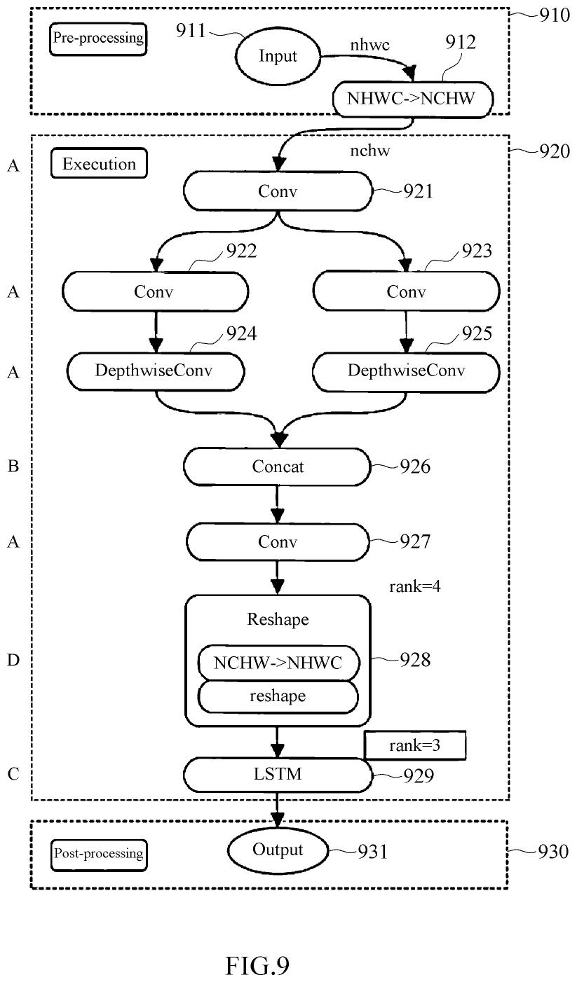

Hereinafter, an example of a working process of the data processing method of the present disclosure is described in combination with an example of FIG. 9.

FIG. 9 illustrates an example of a data processing method of a deep learning inference framework.

Referring to FIG. 9, a layout supported by an inference operator of an inference framework may be an NCHW array, and a layout supported by an inference model may be an NWHC layout.

In an initialization operation, based on an analysis of an original model (a neural network model), the inference framework may determine each operator type and supported input and output data dimension of the original model. In addition, the inference framework may establish an inference model by generating an inference operator and allocating memory according to each operator type and supported input and output data dimensions of the original model. Also, the inference framework may convert constant data of the original model from the NHWC array to the NCHW array. Here, the constant data may include weight data of a Conv layer and a DepthwiseConv layer, thereby conserving a portion of a conversion overhead for the inference process.

In a pre-processing operation 910, when input data is input, a layout of the input data may be converted from the NHWC array to the NCHW array 912. Here, a dimension of input data 911 may be 4 (rank=4).

In an execution operation 920, inference operators corresponding to type A operators (e.g., Conv, DepthwiseConv) 921, 922, 923, 927 may not need data conversion and may be calculated directly.

For a type B operator (e.g., Concat) 926, only adjustment of parameters and then performing of an inference calculation may be needed.

In an example of a Reshape inference operator 928 corresponding to a type D operator, the input data may be Rank=4, and the output data may be Rank=3. That is, since the dimensions of the input data and the output data are different, the corresponding inference operator may need to perform data conversion. Specifically, the Reshape inference operator 928 may convert a layout of the input data from NCHW to NHWC.

In an example of an inference operator corresponding to a type C operator LSTM 929, since the implementation is not related to the data arrangement and the dimensions of the input/output data are all 3, inference calculation may be executed directly.

In a post-processing operation 930, since a dimension of output data 931 is 3 (rank=3), there may be no need for conversion, and the output data 931 may be directly output.

When a layout supported by the inference operator of the inference framework is the NHWC array, and the inference model supports NCWH, a reverse conversion logic may be adopted. That is, an operation of converting NCWH to NHWC may be changed to an operation of converting NHWC to NCWH, and an operation of converting NHWC to NCWH may be changed to an operation of converting NCWH to NHWC.

As such, by using the data processing method of the present disclosure, in the initialization operation, the inference framework may determine each operator type and supported input and output data dimensions of an original model (a neural network model) based on an analysis of the original model, after which an inference operator may be generated accordingly to establish an inference model.

In the pre-processing operation, properties of a predetermined layout supported by the inference model may be assigned to data with a dimension of 4. The same layout properties as the original model may be maintained in data streams with dimensions other than 4.

In the inference operation, a data conversion operation may only appear in an inference operator in which a data dimension is changed, and data conversion operations may be greatly reduced in the inference model. Therefore, the inference performance of a deep learning inference framework for various deep learning layout models may be increased.

In addition, the examples of the present disclosure do not require graph traversal and graph segmentation, so the determination logic of data conversion may be significantly simplified and thereby software development and maintenance costs may be reduced.

In the above, the data processing method of the deep learning inference framework has been described in detail, and hereinafter, a data processing apparatus for a deep learning inference framework is described in detail.

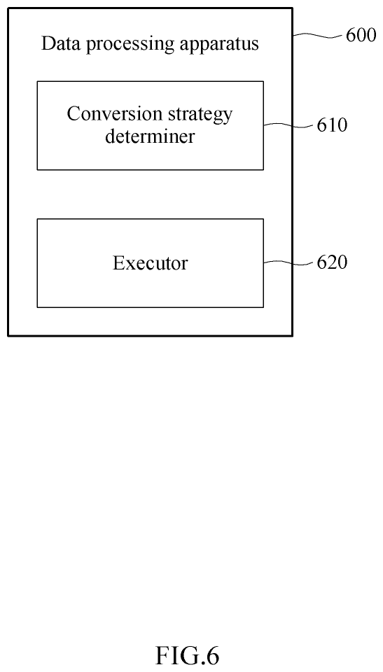

FIG. 6 is a block diagram illustrating an example of a data processing apparatus for a deep learning inference framework.

Referring to FIG. 6, a data processing apparatus 600 may include a conversion strategy determiner 610 and an executor 620. Meanwhile, it will be apparent after an understanding of the disclosure of this application that the data processing apparatus 600 of the present disclosure may further include other components.

For example, the conversion strategy determiner 610 may be configured to, in response to an inference framework not supporting a data arrangement scheme of an inference model, determine a data arrangement scheme conversion strategy of input data and output data of an inference operator, according to a dimension of the input data received by the inference operator, a dimension of the output data correspondingly output, and a correlation between the inference operator and the data arrangement scheme.

For example, the executor 620 may be configured to convert a data arrangement scheme of the input data of the inference operator and/or convert a data arrangement scheme of the output data of the inference operator, according to the determined data arrangement scheme conversion strategy.

For example, the data processing apparatus 600 may further include a pre-processing unit (not shown) that may be configured to convert a data arrangement scheme of input data into a data arrangement scheme supported by an inference framework before inputting the input data to a first layer inference operator of the inference framework, in response to a dimension of the input data being a predetermined dimension. In this example, the predetermined dimension may be determined according to the data arrangement scheme supported by the inference framework and the data arrangement scheme of the inference model.

For example, the data processing apparatus 600 may further include a post-processing unit (not shown) that may be configured to convert a data arrangement scheme of data output from a last layer inference operator of the inference framework into a data arrangement scheme supported by an inference model, in response to a dimension of the data output from the last layer inference operator of the inference framework being the predetermined dimension.

For example, for the determining of the data arrangement scheme conversion strategy of the input data and the output data of the inference operator, the conversion strategy determiner 610 may be configured to verify whether parameters of the inference operator are related to the data arrangement scheme, verify whether the implementation of the inference operator is not related to the data arrangement scheme, and verify whether the dimension of the input data received by the inference operator and the dimension of the output data output corresponding to the input data include only four conditions (as described below).

Here, the four conditions are as follows:

a first condition in which input data of the predetermined dimension is received and output data of the predetermined dimension is output;

a second condition in which the input data of the non-predetermined dimension is received, and the output data of the non-predetermined dimension is correspondingly output;

a third condition in which the input data of the predetermined dimension is received, and the output data of the non-predetermined dimension is correspondingly output;

a fourth condition in which the input data of the non-predetermined dimension is received, and the output data of the predetermined dimension is correspondingly output.

The conversion strategy determiner 610 may be configured to, according to a result of the verifying, determine a conversion strategy for the inference operator in each condition as described below when the dimension of the input data received by the inference operator and the dimension of the output data output corresponding to the input data include only the four conditions.

In the case of the first condition and the second condition, the conversion strategy determiner 610 may be configured to not change the data arrangement scheme of the input data and the output data.

In the case of the third condition, the conversion strategy determiner 610 may be configured to convert the data arrangement scheme of the input data input to the inference operator into the data arrangement scheme of the inference model.

In the case of the fourth condition, the conversion strategy determiner 610 may be configured to convert the data arrangement scheme of the output data of the inference operator into the data arrangement scheme supported by the inference framework.

For example, the conversion strategy determiner 610 may be configured to verify whether parameters of the inference operator are related to the data arrangement scheme, verify whether the implementation of the inference operator is not related to the data arrangement scheme, and verify whether the dimension of the input data received by the inference operator and the dimension of the output data output corresponding to the input data include only two conditions (as described below).

Here, the two conditions are as follows:

a first condition in which input data of the predetermined dimension is received and output data of the predetermined dimension is output;

a second condition in which the input data of the non-predetermined dimension is received, and the output data of the non-predetermined dimension is correspondingly output.

According to a result of the verifying, the conversion strategy determiner 610 may be configured to determine a conversion strategy for the inference operator in each condition as described below when the dimension of the input data received by the inference operator and the dimension of the output data output corresponding to the input data include only the two conditions.

In the case of the first condition, the conversion strategy determiner 610 may be configured to not need to convert the arrangement schemes of the input data and the output data, nor adjust the parameters of the inference operator.

In the case of the second condition, the conversion strategy determiner 610 may be configured to not convert the data arrangement schemes of the input data and the output data of the inference operator, but adjust the parameters of the inference operator.

For example, the conversion strategy determiner 610 may be configured to determine the data arrangement scheme conversion strategy of the input data and the output data of the inference operator when executing the inference operator. In another example, the conversion strategy determiner 610 may be configured to determine the data arrangement scheme conversion strategy of the input data and the output data of the inference operator before executing the inference operator.

For example, the predetermined dimension may be 4. In addition, the data arrangement scheme of the inference model may be NHWC, and the data arrangement scheme supported by the inference framework may be NCWH. In another example, the data arrangement scheme of the inference model may be NCWH, and the data arrangement scheme supported by the inference framework may be NHWC.

The data processing apparatus, conversion strategy determiner, executor, conversion strategy determiner 610 and executor 620 in FIGS. 3-9 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 3-9 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented data processing method, the method comprising:
determining whether an inference framework for a deep learning inference framework supports a first data arrangement scheme of a machine learning inference model;
determining, in response to the inference framework not supporting the first data arrangement scheme, a data arrangement scheme conversion strategy of input data and output data of an inference operator of the inference framework, based on a dimension of the input data received by the inference operator, a dimension of the output data output corresponding to the input data, and a correlation between the inference operator and the data arrangement scheme; and
converting either a data arrangement scheme of the input data or the output data of the inference operator based on the determined data arrangement scheme conversion strategy.

2. The method of claim 1, further comprising:
pre-processing the input data based on the dimension of the input data before inputting the input data to a first layer inference operator of the inference framework,
wherein the pre-processing comprises:
converting, in response to the dimension of the input data being a predetermined dimension, the first data arrangement scheme of the input data into a second data arrangement scheme, different from the first data arrangement scheme, supported by the inference framework, and
the predetermined dimension being determined based on the second data arrangement scheme supported by the inference framework and the first data arrangement scheme of the machine learning inference model.

3. The method of claim 1, further comprising:
post-processing output data output from a last layer inference operator of the inference framework, based on a dimension of the output data output from the last layer inference operator of the inference framework,
wherein the post-processing comprises:
converting, in response to a dimension of the data output from the last layer inference operator of the inference framework being the predetermined dimension, a data arrangement scheme of the data output from the last layer inference operator of the inference framework into the second data arrangement scheme supported by the machine learning inference model.

4. The method of claim 1, wherein the determining of the data arrangement scheme conversion strategy of the input data and the output data of the inference operator comprises:
verifying whether parameters of the inference operator are related to the data arrangement scheme of the input data and the output data, verifying whether implementation of the inference operator is not related to the data arrangement scheme of the input data and the output data, and verifying whether the dimension of the input data received by the inference operator and the dimension of the output data output corresponding to the input data comprise only four conditions, and
the four conditions comprise:
a first condition of receiving input data of the predetermined dimension and outputting output data of the predetermined dimension;
a second condition of receiving input data of a non-predetermined dimension and correspondingly outputting output data of the non-predetermined dimension;
a third condition of receiving the input data of the predetermined dimension and correspondingly outputting the output data of the non-predetermined dimension; and
a fourth condition of receiving the input data of the non-predetermined dimension and correspondingly outputting the output data of the predetermined dimension.

5. The method of claim 4, wherein the determining of the data arrangement scheme conversion strategy of the input data and the output data of the inference operator comprises:
converting the data arrangement scheme of the input data input to the inference operator into the first data arrangement scheme of the machine learning inference model in the third condition, in response to the dimension of the input data received by the inference operator and the dimension of the output data output corresponding to the input data comprising only the four conditions based on a result of the verifying.

6. The method of claim 4, wherein the determining of the data arrangement scheme conversion strategy of the input data and the output data of the inference operator comprises:
converting the data arrangement scheme of the output data of the inference operator into the second data arrangement scheme supported by the inference framework in the fourth condition, in response to the dimension of the input data received by the inference operator and the dimension of the output data output corresponding to the input data comprising only the four conditions based on the result of the verifying.

7. The method of claim 4, wherein the determining of the data arrangement scheme conversion strategy of the input data and the output data of the inference operator comprises:
not converting the data arrangement schemes of the input data and the output data of the inference operator in the first condition and the second condition, in response to the dimension of the input data received by the inference operator and the dimension of the output data output corresponding to the input data comprising only the four conditions based on the result of the verifying.

8. The method of claim 1, wherein the determining of the data arrangement scheme conversion strategy of the input data and the output data of the inference operator comprises:
verifying whether the parameters of the inference operator are related to the data arrangement scheme, verifying whether implementation of the inference operator is not related to the data arrangement scheme, and verifying whether the dimension of the input data received by the inference operator and the dimension of the output data output corresponding to the input data comprise only two conditions, and
the two conditions comprise:
a first condition of receiving input data of a predetermined dimension and outputting output data of the predetermined dimension; and
a second condition of receiving input data of a non-predetermined dimension and correspondingly outputting output data of the non-predetermined dimension.

9. The method of claim 8, wherein the determining of the data arrangement scheme conversion strategy of the input data and the output data of the inference operator comprises:
not converting the data arrangement schemes of the input data and the output data of the inference operator and adjusting the parameters of the inference operator in the second condition, in response to the dimension of the input data received by the inference operator and the dimension of the output data output corresponding to the input data comprising only the two conditions based on the result of the verifying.

10. The method of claim 8, wherein the determining of the data arrangement scheme conversion strategy of the input data and the output data of the inference operator comprises:
not converting the data arrangement schemes of the input data and the output data of the inference operator and not adjusting the parameters of the inference operator in the first condition, in response to the dimension of the input data received by the inference operator and the dimension of the output data output corresponding to the input data comprising only the two conditions based on the result of the verifying.

11. The method of claim 1, wherein the determining of the data arrangement scheme conversion strategy of the input data and the output data of the inference operator comprises:
determining the data arrangement scheme conversion strategy of the input data and the output data of the inference operator in response to the inference operator being executed; or
determining the data arrangement scheme conversion strategy of the input data and the output data of the inference operator prior to the inference operator being executed.

12. The method of claim 2, wherein the predetermined dimension is 4, and
the first data arrangement scheme of the machine learning inference model is NHWC, and the second data arrangement scheme supported by the inference framework is NCWH, or
the first data arrangement scheme of the machine learning inference model is NCWH, and the second data arrangement scheme supported by the inference framework is NHWC.

13. A non-transitory computer-readable storage medium storing instructions that, when executed by a processor, cause the processor to perform the method of claim 1.

14. A data processing apparatus, the apparatus comprising:
a conversion strategy determiner configured to, in response to an inference framework for a deep learning inference framework not supporting a first data arrangement scheme of a machine learning inference model, determine a data arrangement scheme conversion strategy of input data and output data of an inference operator of the inference framework, based on a dimension of the input data received by the inference operator, a dimension of the output data output corresponding to the input data, and a correlation between the inference operator and the data arrangement scheme; and
an executor configured to convert either a data arrangement scheme of the input data or output data of the inference operator based on the determined data arrangement scheme conversion strategy.

15. The apparatus of claim 14, further comprising:
a pre-processor configured to:
pre-process the input data based on the dimension of the input data before inputting the input data to a first layer inference operator of the inference framework; and
convert, in response to the dimension of the input data being a predetermined dimension, the data arrangement scheme of the input data into a second data arrangement scheme, different from the first data arrangement scheme, supported by the inference framework,
wherein the predetermined dimension is determined based on the second data arrangement scheme supported by the inference framework and the first data arrangement scheme of the machine learning inference model.

16. The apparatus of claim 14, further comprising:
a post-processor configured to:
post-process output data output from a last layer inference operator of the inference framework, based on a dimension of the output data output from the last layer inference operator of the inference framework; and
convert, in response to a dimension of the data output from the last layer inference operator of the inference framework being the predetermined dimension, a data arrangement scheme of the data output from the last layer inference operator of the inference framework into the second data arrangement scheme supported by the machine learning inference model.

17. The apparatus of claim 14, wherein the conversion strategy determiner is further configured to verify whether parameters of the inference operator are related to the data arrangement scheme, and implementation of the inference operator is not related to the data arrangement scheme, and the dimension of the input data received by the inference operator and the dimension of the output data output corresponding to the input data comprise only four conditions, and
the four conditions comprise:
a first condition of receiving input data of the predetermined dimension and outputting output data of the predetermined dimension;
a second condition of receiving input data of a non-predetermined dimension and correspondingly outputting output data of the non-predetermined dimension;
a third condition of receiving the input data of the predetermined dimension and correspondingly outputting the output data of the non-predetermined dimension; and
a fourth condition of receiving the input data of the non-predetermined dimension and correspondingly outputting the output data of the predetermined dimension.

18. The apparatus of claim 17, wherein the conversion strategy determiner is further configured to:
in response to the dimension of the input data received by the inference operator and the dimension of the output data output corresponding to the input data comprising only the four conditions based on the result of the verifying, not convert the data arrangement schemes of the input data and the output data of the inference operator in the first condition and the second condition;
convert the data arrangement scheme of the input data input to the inference operator into the first data arrangement scheme of the machine learning inference model in the third condition; and
convert the data arrangement scheme of the output data of the inference operator into the second data arrangement scheme supported by the inference framework in the fourth condition.

19. The apparatus of claim 14, wherein the conversion strategy determiner is further configured to:
verify whether the parameters of the inference operator are related to the data arrangement scheme, and implementation of the inference operator is not related to the data arrangement scheme,
wherein the dimension of the input data received by the inference operator and the dimension of the output data output corresponding to the input data comprise only two conditions, and
the two conditions comprise:
a first condition of receiving input data of a predetermined dimension and outputting output data of the predetermined dimension; and
a second condition of receiving input data of a non-predetermined dimension and correspondingly outputting output data of the non-predetermined dimension is correspondingly output.

20. The apparatus of claim 19, wherein the conversion strategy determiner is further configured to:
in response to the dimension of the input data received by the inference operator and the dimension of the output data output corresponding to the input data comprising only the two conditions based on the result of the verifying, not convert the data arrangement schemes of the input data and the output data of the inference operator and not adjust the parameters of the inference operator in the first condition; and
not convert the data arrangement schemes of the input data and the output data of the inference operator and adjust the parameters of the inference operator in the second condition.
